(19) United States
(12) Patent Application Publication
(10) Pub. No.: US 2009/0297814 A1
(43) Pub. Date: Dec. 3, 2009

(54) Innerliner With Cross-Linked Eva

(76) Inventors: Kevin J. Curie, Appleton, WI (US); Robert John Blemberg, Appleton, WI (US)

Correspondence Address: BANNER & WITCOFF, LTD., TEN SOUTH WACKER DRIVE, SUITE 3000, CHICAGO, IL, 60606, US

(21) Appl. No.: 12/473,323

(22) Filed: May 28, 2009

Related U.S. Application Data
(60) Provisional application No. 61/056,505, filed on May 28, 2008.

(51) Int. Cl. B32B 27/08

(52) U.S. Cl. 428/220

(57) ABSTRACT

A multilayer film comprising, a cross-linked ethylene copolymer layer such as ethylene vinyl acetate layer, an HDPE layer, and a sealant layer, for use, for example, to form a package for dry food products. The multilayer film has a thickness of less than about 2.0 mils, such as between 1-1.5 mils and a tear strength in the machine direction of greater than 40 grams.

This application claims priority to U.S. provisional application 61/056,505, filed May 28, 2009, and hereby incorporated by reference in its entirety.

### FIELD

The invention relates to a multilayer product, in particular an innerliner, prepared from cross-linked ethylene copolymers such as ethylene vinyl acetate.

### BACKGROUND

Downgauging (reducing thickness) packaging has been an ongoing trend to improve economics and increase sustainability. For bag-in-box applications for dry food products (such as a cereal, crackers, or snack), key attributes for the plastic film innerliner are moisture barrier and abuse resistance (e.g. tear and puncture strength.). A conventional multilayer film structure useful for innerliners is, for example, (2-2.5 mil) HDPE/HDPE/Sealant.

By using the recently developed high barrier HDPE resins (such as Nova's SURPASS) the required barrier can be achieved with a relatively thin layer of HDPE (0.6-0.8 mils). However, at this thickness (with a conventional sealant layer), the film lacks adequate stiffness and abuse resistance.

One approach to downgauging of a plastic package is to machine direction orient a blown or cast film. The orientation improves barrier and many key physical properties. However, with an HDPE based film typical of an innerliner package, the film becomes splitty (weak) in the machine direction. This can lead to a compromise in package performance, especially during opening of the package.

In addition to an HDPE based moisture barrier, innerliner packages may also contain nylon (or EVOH) for oxygen protection. When prepared using the blown film process, the nylon freezes up first during cooling, followed by the HDPE. As a result, because HDPE goes through a large volume change from melt to solid, the film curls. A film that curls significantly is difficult to process on packaging machines.

Many high moisture barrier HDPE innerliner films with a surface HDPE outside layer result in a powder build up on the customer filling equipment. This powder is primarily low molecular weight HDPE.

### SUMMARY

The present invention provides a multilayer film comprising cross-linked ethylene copolymers such as cross-linked ethylene vinyl acetate suitable for use as innerlayers.

In an aspect of the invention, a multilayer film is provided that comprises a cross-linked EVA layer, a high density polyethylene layer, and a sealant layer. The multilayer film has a thickness of less than about 2 mils and a tear strength in the machine direction of at least 40 grams. In certain aspects, the multilayer film has a thickness of between 1 and 1.5 mils. In further aspects, the EVA layer and the HDPE layer may be blended and then cross-linked. In further aspects, the EVA layer is cross-linked with electron beam radiation.

### BRIEF DESCRIPTION OF THE DRAWINGS

FIG. 1 illustrates a cross-section of a multilayer polymeric film comprising three layers.

FIG. 2 illustrates a cross-section of a multilayer polymeric film comprising four layers.

### DETAILED DESCRIPTION

An aspect of the invention is directed to the use of a layer of ethylene vinyl acetate (“EVA”) which is cross-linked by electron beam (E-beam) radiation. The cross-linked EVA is used in a multi layer film structure to form, for example, an innerliner for packages. In addition to EVA, any suitable ethylene copolymer which is cross-linked by E-beam radiation may be used such as ethylene acrylate (“EAA”) and ethylene methyl acrylate (“EMA”) although for convenience, EVA will be discussed.

Advantages of the cross-linked EVA include improved physical properties at a much thinner gauge than conventional innerliner film structures and excellent heat resistance on the outside of the package. The cross-linked EVA provides abuse resistance in both tear strength and puncture strength. If the cross-linked EVA is on the outside, it will also provide heat resistance and prevent powder build up.

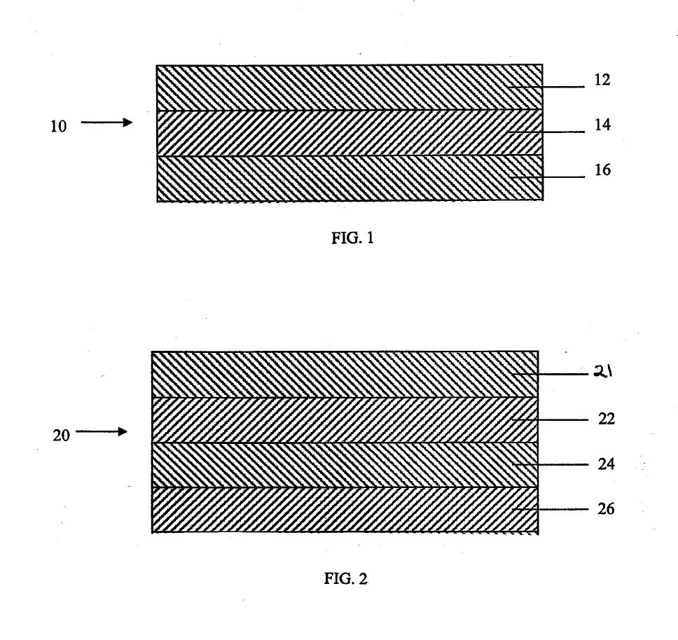

Aspects of the invention are particularly directed to multilayer structures comprising EVA/HDPE/sealant. Referring to FIG. 1, in accordance with one aspect of the invention, a three layer multilayer film 10 comprises layers 12, 14, and 16, and has the following structure, from outer layer to inner sealant layer: EVA (12)/HDPE (14)/sealant (168). It is also possible to blend EVA into a layer of HDPE and cross-link that layer to produce an film comprising EVA-HDPE blend/sealant.

As used herein EVA refers to ethylene vinyl acetate containing greater than 5% vinyl acetate. The EVA is cross-linked, in particular with electron beam (E-beam) radiation.

As used herein, the phrase high density polyethylene (“HDPE”) refers to ethylene alpha-olefin copolymers or ethylene homopolymer having a density of about 0.94 g/cm³ or greater. HDPE can be produced with several classes of catalysts, such as Ziegler-Natta catalysts and metallocene catalysts.

Suitable HDPE is available from Nova Chemicals. Nova-SURPASS® HDPE includes high density polyethylene and a nucleating agent to achieve the moisture barrier and other physical properties. Because of the increased moisture barrier, a thinner layer of HDPE may be used to provide the same moisture vapor transmission rate, and thus the HDPE portion of the structure can be downgauged. The HDPE layer may have a thickness of about 0.48 mils, for example. In certain aspects of the invention, the HDPE layer may have a thickness as low as 0.3 mils.

Another suitable HDPE is Alathon® L5885, which has a melt index of about 0.85 g/10 min and a density of about 0.958 g/cm³. Alathon® L5885 is available from LyondellBasell Industries, Houston, Tex. A further suitable HDPE is Elite® 5960G HDPE, which has a melt index of about 0.85 g/10 min and a density of about 0.962 g/cm³. Elite® 5960G HDPE is available from The Dow Chemical Company, Midland, Mich.

As used herein, the sealant layer provides the ability for the film to be sealed to its own outer surface layer or to another multilayer film structure, so as to form the innerliner package.

The sealant layer may be heat sealable. The term “heat sealable,” as used herein, means sealable or bondable by heat however obtained, for example, by induction or magnetic, ultrasonic, radio frequency, light, or other energy sources which cause the materials to bond, fuse or otherwise seal. Such heat sealable materials usually are thermoplastic film forming polymers, are well-known in the art, and include an ionomer, such as Surlyn®, LLDPE, including all linear polyethylenes with density up to about 0.95 g/cc, LDPE, ethylene vinyl acetate, polybutylene, polypropylene-based plastomers, homopolymers or random copolymers, medium density polyethylene (MDPE), high density polyethylene (HDPE), ultra low density polyethylene, very low density polyethylene, olefins catalyzed by a single site catalyst such as metallocene or a blend of any of these polymers.

The sealant layer may also include additives for high speed processing, such as slip additive and antiblock compound. Further, the sealant layer may comprise materials to provide a peelable seal, for instance any suitable compound that is incompatible with the selected sealant materials. The presence of the incompatible material will decrease the strength of the sealed bond and thereby also decrease the amount of force required to break the seal

Various layers of the multilayer film structure may be adhered together with tie, or adhesive layers. In an embodiment, a tie or adhesive layer may be a coextrusion of low density polyethylene (LDPE) and ethylene acrylic acid copolymer (EAA) or an anhydride modified polyethylene. In certain embodiments, the tie or adhesive layer comprises linear low density polyethylene (LLDPE)-based adhesive. The tie or adhesive layer may alternatively comprise any of the various other polymeric adhesives commonly used in the art of making multilayer films.

If an oxygen (O₂) barrier is required, the EVA/HDPE/sealant film can be coated with a high barrier coating, such as NANOSEAL providing the following structure: NANOSEAL (21)/EVA (22)/HDPE (24)/sealant (26). This package can be provided with or without an O₂ barrier with little impact on manufacturing process.

EVA provides additional strength to the multilayer structure such that the film can be downgauged to less than 2 mil, such as about 1 to about 1.5 mil, typically about 1.2 mil. Moreover, the edge trim can be recycled for cost savings. Material cost savings with EVA can be up to 30%. The tear strength of the multilayer film is at least 40 grams, generally 40 to 200 grams, and in particular 70 to 125 grams.

An advantage of downgauging a multilayer film structure for use as a package is that the thinner film structure has a more transparent appearance than a conventional film structure currently used for innerliner packages.

The multilayer film structure of the present invention provides numerous advantages over multilayer film structures previously used to form innerliner packages for dry food products. Further, the use of Nova-SURPASS HDPE allows the moisture barrier to be doubled. Because of the increased moisture barrier, the HDPE part of the structure can also be downgauged. This provides an innerliner structure with even lower costs. Further, this Nova-SURPASS HDPE product also eliminates curl that can be a difficult issue when processing the material film on packaging machines.

Multilayer film structures of embodiments of the invention may be made via cast coextrusion, extrusion coating and/or extrusion lamination, adhesive lamination, blown-film coextrusion or water-quenched coextrusion or any other film-making method generally known to those having ordinary skill in the art. In certain embodiments, the layers of the film are cast coextruded together. In embodiments of the invention, the multilayer film is oriented during production. Orienting the film in the machine direction increases machine direction tear strength, gives the film better stiffness, and increases barrier properties. Because the standard cast process also imparts some machine direction orientation during film extrusion, the addition of a polyamide layer is also beneficial to improvement in machine direction tear when the film structures are prepared using cast coextrusion.

Moisture barrier and stiffness can be improved by machine direction orienting the film. In addition, the HDPE layer may be co-extruded with a layer of nylon. This co-extrusion unexpectedly prevents the film from easily splitting in the machine direction after the machine direction orientation process. Because of standard cast process also imparts some machine direction orientation during film extrusion, the addition of a nylon layer is also beneficial to improvement in machine direction tear in that process.

### EXAMPLES

The following examples are illustrative of embodiments of the present invention, as described above, and are not meant to limit the invention in any way.

### Example 1

The following inner liners may be made in accordance with the present invention by coextruding the following layers to form multilayer films. The EVA and EVA+HDPE are cross-linked by e-beam radiation.
EVA/HDPE/ionomer
EVA/EVA+HDPE/ionomer
EVA+HDPE/LLDPE
EVA/HDPE/LLDPE machine direction oriented at 3:1 to 7:1

Ionomer is a general term for surlyn—partially neutralized ethylene acid copolymers. Any of the above may be nanocoated with to provide an oxygen barrier. Suitable nanocoatings may be provided, for example, by “NanoSeal” produced by NanoPack.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

We claim:

1. A multilayer film comprising a cross-linked ethylene copolymer layer, a high density polyethylene (HDPE) layer, and a sealant layer the multilayer film having a thickness of less than about 2 mils, the multilayer film exhibiting a tear strength in the machine direction of at least 40 grams.

2. The multilayer film of claim 2 wherein the cross-linked ethylene ethylene copolymer layer is cross-linked by electron beam radiation.

3. The multilayer film of claim 1 wherein the ethylene copolymer is ethylene vinyl acetate, ethylene acrylate, or ethylene methyl acrylate.

4. The multilayer film of claim 1 wherein the cross-linked ethylene copolymer layer is a cross-linked ethylene vinyl acetate layer.

5. The multilayer film of claim 4 wherein the cross-linked ethylene vinyl acetate film is cross-linked by electron beam radiation.

6. The multilayer film of claim 1 wherein the film thickness is about 1 to about 1.5 mil.

7. The multilayer film of claim 1 wherein the film thickness is about 1.2 mil.

8. The multilayer film of claim 1 further comprising an oxygen barrier layer.

9. The multilayer film of claim 1 wherein the film is oriented by machine direction orientation.

10. The multilayer film of claim 1 wherein the cross-linked ethylene copolymer layer and HDPE layer are formed as a single layer by blending ethylene vinyl acetate with HDPE prior to being cross-linked.

11. The multilayer film of claim 1 wherein the HDPE layer is a blend of ethylene vinyl acetate with the HDPE.

12. The multilayer film of claim 1 further comprising an oxygen barrier coating over the ethylene copolymer layer.

13. The multilayer film of claim 1 wherein the tear strength is about 40 to about 200 grams.

14. The multilayer film of claim 1 wherein the tear strength is about 70 to about 125 grams

15. An innerliner package comprising the multilayer film of claim 1.

16. The innerliner package of claim 15 wherein the cross-linked ethylene copolymer layer is a buried layer of the package.

17. The innerliner package of claim 15 wherein the cross-linked ethylene copolymer layer is the outside layer of the package.

18. A multilayer film comprising, a cross-linked ethylene vinyl acetate layer, an HDPE layer, and a sealant layer.

19. The multilayer film of claim 18 further comprising an oxygen barrier coating over the ethylene vinyl acetate layer.

20. An innerliner package comprising the multilayer film of claim 18.
